(19) United States
(12) Patent Application Publication
(10) Pub. No.: US 2023/0087958 A1
(43) Pub. Date: Mar. 23, 2023

(54) VEHICULAR DISPLAY DEVICE, VEHICLE, DISPLAY METHOD, AND NON-TRANSITORY COMPUTER-READABLE MEDIUM STORING PROGRAM

(71) Applicant: TOYOTA JIDOSHA KABUSHIKI KAISHA, Toyota-shi (JP)

(72) Inventors: Ryo OGATA, Toyota-shi (JP); Kento NAGASHIMA, Toyota-shi (JP)

(73) Assignee: TOYOTA JIDOSHA KABUSHIKI KAISHA, Toyota-shi (JP)

(21) Appl. No.: 17/875,986

(22) Filed: Jul. 28, 2022

(30) Foreign Application Priority Data
Sep. 21, 2021 (JP) 2021-153379

(51) Int. Cl. B60K 35/00; G08G 1/16

(52) U.S. Cl. CPC B60K 35/00; G08G 1/166; G08G 1/167; B60K 2370/1529; B60K 2370/179

(57) ABSTRACT

A vehicular display device including: a memory; and a processor coupled to the memory, the processor being configured to: in a case in which information has been acquired regarding a first other vehicle present in a first range of surroundings of a vehicle, display a position of the first other vehicle at a display region provided in front of a driving seat; and in a case in which information has been acquired regarding a second other vehicle present in a second range further outward than the first range, display at the display region a direction indicating where the second other vehicle is located.

### CROSS-REFERENCE TO RELATED APPLICATION

This application claims priority under 35 USC 119 from Japanese Patent Application No. 2021-153379, filed on Sep. 21, 2021, the disclosure of which is incorporated by reference herein.

### BACKGROUND

### Technical Field

The present disclosure relates to a vehicular display device, a vehicle, a display method, and a non-transitory computer-readable medium storing a program.

### Related Art

Japanese Patent Application Laid-Open (JP-A) No. 2019-119262 discloses a head-up display device which displays a prior notice in front of a driving seat to advise of a change in driving modes in a vehicle that has plural driving modes including an autonomous driving mode. In the head-up display device disclosed in JP-A No. 2019-119262, marking images are generated based on pictures of vehicles in front and oncoming vehicles captured by a camera, and these images are displayed in a display region.

However, an occupant is not alerted in a case in which a vehicle suddenly approaches from outside the display region. Moreover, in a case in which the vehicle accelerates or decelerates autonomously due to a vehicle outside the display region, the occupant may not be able to ascertain the cause of this acceleration or deceleration, and might feel concern as a result.

### SUMMARY

The present disclosure provides a vehicular display device, a vehicle, a display method, and a non-transitory computer-readable medium storing a program that enable any concern felt by an occupant to be suppressed.

A first aspect of the present disclosure is a vehicular display device including: a memory; and a processor coupled to the memory, the processor being configured to: in a case in which information has been acquired regarding a first other vehicle present in a first range of surroundings of a vehicle, display a position of the first other vehicle at a display region provided in front of a driving seat; and in a case in which information has been acquired regarding a second other vehicle present in a second range further outward than the first range, display at the display region a direction indicating where the second other vehicle is located.

In the vehicular display device according to the first aspect, the position of the first other vehicle is displayed in the display region provided in front of the driving seat, thereby enabling the attention of a driver to be directed toward the first other vehicle present in the first range in the vehicle surroundings.

Moreover, in a case in which the second other vehicle is present in the second range that is further outward than the first range, the direction indicating where the second other vehicle is present is displayed in the display region. This enables any concern felt by the driver toward a vehicle approaching from outside the display region to be suppressed.

In a second aspect of the present disclosure, in the first aspect, the processor may be configured to display the direction indicating where the second other vehicle is located, in a case in which a distance to the second other vehicle is decreasing, and not to display the direction in a case in which a distance to the second other vehicle is increasing.

In the vehicular display device according to the second aspect, only the direction of a second other vehicle that is approaching the vehicle is displayed in the display region, thereby may enable the display of unnecessary information from the perspective of the driver to be suppressed.

In a third aspect of the present disclosure, in any one of the above aspects, the processor may be configured to display the direction indicating where the second other vehicle is located, when traveling in a driving assistance mode in which acceleration and deceleration of the vehicle is performed without any driving operation intervention by an occupant.

In the vehicular display device according to the third aspect, since the direction of the second other vehicle is displayed in the display region, an occupant can ascertain that any acceleration or deceleration is being performed as a result of the second other vehicle in a case in which the vehicle has accelerated or decelerated without any driving operation intervention by the occupant.

In a fourth aspect of the present disclosure, in any one of the above aspects, the processor may be configured to display the direction indicating where the second other vehicle is located, as an animation.

In the vehicular display device according to the fourth aspect, since the direction is displayed as an animation, the attention of the driver may be better directed toward the second other vehicle.

In a fifth aspect of the present disclosure, in any one of the first aspect to the third aspect, the processor may be configured to display the direction indicating where the second other vehicle is located, using text.

In the vehicular display device according to the fifth aspect, displaying the direction using text enables the driver to be accurately made aware that the second other vehicle is present.

In a sixth aspect of the present disclosure, in any one of the above aspects, the processor may be configured to perform display in a case in which the second other vehicle is traveling along a merging lane.

In the vehicular display device according to the sixth aspect, the driver can be made aware of the direction of the second other vehicle that is merging in a case in which the second other vehicle is merging from the merging lane.

A seventh aspect of the present disclosure is a vehicle including the vehicular display device of any one of the above aspects, and a head-up display device configured to display information regarding the first other vehicle and the direction indicating where the second other vehicle is located in the display region, which is set on a windshield glass.

In the vehicle according to the seventh aspect, the direction of the second other vehicle is displayed on the display region set on the windshield glass by the head-up display device. This enables the driver to ascertain the direction of the second other vehicle in a state in which their gaze is directed toward the front.

An eighth aspect of the present disclosure is a vehicle including the vehicular display device of any one of the first aspect to the sixth aspect, and a display provided inside a cabin of the vehicle and including the display region.

In the vehicle according to the eighth aspect, the direction of the second other vehicle is displayed on the display inside the vehicle cabin, thereby enabling occupants other than the driver to be made aware of the direction of the second other vehicle.

A ninth aspect of the present disclosure is a display method including: in a case in which information has been acquired regarding a first other vehicle present in a first range of surroundings of a vehicle, displaying a position of the first other vehicle at a display region, which is provided in front of a driving seat; and in a case in which information has been acquired regarding a second other vehicle present in a second range further outward than the first range, display at the display region a direction indicating where the second other vehicle is located.

A tenth aspect of the present disclosure is a non-transitory computer-readable medium storing a program for causing a computer to execute processing including: in a case in which information has been acquired regarding a first other vehicle present in a first range of surroundings of a vehicle, displaying a position of the first other vehicle at a display region, which is provided in front of a driving seat; and in a case in which information has been acquired regarding a second other vehicle present in a second range further outward than the first range, display at the display region a direction indicating where the second other vehicle is located.

In the above aspects, the vehicular display device, the vehicle, the display method, and the non-transitory computer-readable medium storing a program according to the present disclosure enable any concern felt by the occupant may be suppressed.

### BRIEF DESCRIPTION OF THE DRAWINGS

Exemplary embodiments will be described in detail based on the following figures, wherein:

FIG. 1 is a schematic view of a front section inside a cabin of a vehicle applied with a vehicular display device according to an exemplary embodiment, as viewed from a vehicle rear side;

FIG. 2 is a block diagram illustrating a hardware configuration of a vehicle according to an exemplary embodiment;

FIG. 3 is a block diagram illustrating a functional configuration of a vehicular display device according to an exemplary embodiment;

FIG. 4 is a diagram illustrating an example of a display in a display region in an exemplary embodiment, in which a direction of a second other vehicle is displayed;

FIG. 5 is a diagram illustrating an example of a display in a display region in an exemplary embodiment, in which a position of a first other vehicle is displayed; and

FIG. 6 is a flowchart illustrating an example of a flow of display processing in an exemplary embodiment.

### DETAILED DESCRIPTION

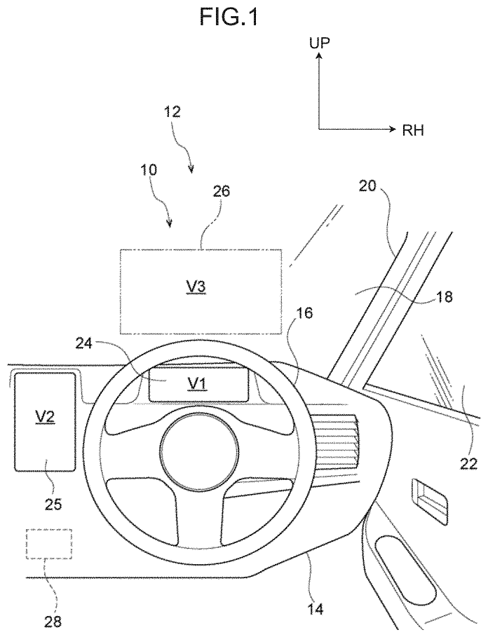

Explanation follows regarding a vehicle 10 installed with a vehicular display device 28 according to an exemplary embodiment, with reference to the drawings. Note that in FIG. 1, the arrow UP indicates an upper side in a vehicle vertical direction, and the arrow RH indicates a right side in a vehicle width direction. In the following explanation, reference to a vertical direction and a left-right direction respectively refer to vertical in the vehicle vertical direction and left and right in the vehicle width direction.

As illustrated in FIG. 1, an instrument panel 14 is provided to a front section inside a cabin of the vehicle 10. The instrument panel 14 extends along the vehicle width direction, and a steering wheel 16 is provided on the vehicle right side of the instrument panel 14. Namely, in the present exemplary embodiment as an example, the vehicle is a right-hand drive vehicle in which the steering wheel 16 is provided on the right side, and a driving seat is set on the vehicle right side.

A windshield glass 18 is provided at a front end section of the instrument panel 14. The windshield glass 18 extends along the vehicle vertical direction and the vehicle width direction so as to partition between the vehicle cabin interior and vehicle cabin exterior.

A vehicle right side end portion of the windshield glass 18 is fixed to a front pillar 20 on the vehicle right side. The front pillar 20 extends along the vehicle vertical direction. The windshield glass 18 is fixed to a vehicle width direction inside end portion of the front pillar 20. A front end portion of a front side glass 22 is fixed to a vehicle width direction outside end portion of the front pillar 20. Note that a vehicle left side end portion of the windshield glass 18 is fixed to a non-illustrated front pillar on a vehicle left side.

A first display section 24 including an image display region V1 is provided on the instrument panel 14. The first display section 24 is configured by a meter display provided at a vehicle front side of the driving seat and on the vehicle right side of the instrument panel 14. The first display section 24 is connected to various meter equipment installed to the vehicle 10, and is provided at a position that enters the field of view of a driver in a state in which their gaze is directed toward the vehicle front.

A second display section 25 including an image display region V2 is also provided on the instrument panel 14. The second display section 25 is configured by a center display installed at a vehicle width direction central section of the instrument panel 14.

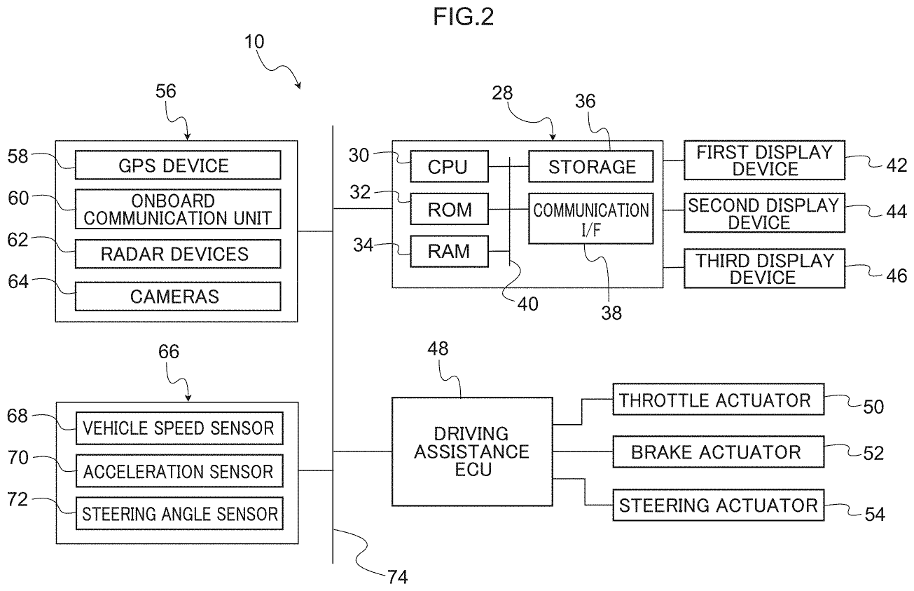

A third display section 26 including an image display region V3 is provided on the windshield glass 18. The third display section 26 is set at the vehicle upper side of the first display section 24, and is configured by a projection surface that a third display device 46 configuring a head-up display device (see FIG. 2) projects onto. Specifically, the third display device 46 is provided at the vehicle front side of the instrument panel 14, and images are projected onto the third display section 26 on the windshield glass 18 from the third image display device 46. Namely, the third display section 26 configures a part of the windshield glass 18 that serves as the projection surface of the third image display device 46.

Note that the vehicular display device 28 is provided to the vehicle 10. The vehicular display device 28 of the present exemplary embodiment is for example a display electronic control unit (ECU) that performs various controls.

As illustrated in FIG. 2, the vehicle 10 is configured including the vehicular display device 28, a surroundings information acquisition sensor set 56, a vehicle information acquisition sensor set 66, and a driving assistance ECU 48. These respective elements are connected so as to be capable of communicating with one another through a communication bus 74.

The vehicular display device 28 is configured including a central processing unit (CPU; processor) 30, read only memory (ROM) 32, random access memory (RAM) 34, storage 36, and a communication interface (communication I/F) 38. The respective configuration elements are connected so as to be capable of communicating with one another through an internal bus 40.

The CPU 30 is a central processing unit that executes various programs and controls respective sections. Namely, the CPU 30 reads a program from the ROM 32 or the storage 36, and executes the program using the RAM 34 as a workspace. The CPU 30 also controls the respective configuration elements and performs various arithmetic processing according to the programs recorded in the ROM 32 or the storage 36.

The ROM 32 holds various programs and various data. The RAM 34 acts as a workspace to temporarily store programs or data. The storage 36 is configured by a hard disk drive (HDD) or a solid state drive (SSD), and is a non-transitory recording medium that holds various programs including an operating system, and various data. In the present exemplary embodiment, programs such as a display program for performing display processing are held in the ROM 32 or the storage 36.

The communication I/F 38 is an interface enabling the vehicular display device 28 to communicate with an external server and other equipment, and a standard such as a Controller Area Network (CAN), Ethernet (registered trademark), Long Term Evolution (LTE), Fiber Distributed Data Interface (FDDI), or Wi-Fi (registered trademark) may be employed therefor.

A first display device 42, a second display device 44, and the third display device 46 are connected to the vehicular display device 28. The first display device 42 displays pictures in the display region V1 of the first display section 24. The second display device 44 displays pictures in the display region V2 of the second display section 25. The third display device 46 displays pictures in the display region V3 of the third display section 26.

The surroundings information acquisition sensor set 56 is configured including a global positioning system (GPS) device 58, an onboard communication unit 60, radar devices 62, and cameras 64.

The GPS device 58 receives GPS signals from plural GPS satellites to locate the position of the ego vehicle. The onboard communication unit 60 is a communication device that is capable of vehicle-to-vehicle communication with other vehicles, vehicle-to-infrastructure communication with road infrastructure, and so on.

The radar devices 62 are sensors for detecting objects such as pedestrians and other vehicles present in a peripheral area around the vehicle, and are configured including plural radar devices that each have different detection ranges. The radar devices 62 may for example be configured including a LIDAR (light detection and ranging) device. The radar devices 62 may be configured so as to acquire the position and speed of each of the detected objects relative to the ego vehicle.

The cameras 64 image the peripheral area around the vehicle and output the captured images. For example, the cameras 64 are configured including a forward-facing camera that images ahead of the vehicle, a rearward-facing camera that images behind the vehicle, side-facing cameras that image both left and right sides of the vehicle, and so on.

The vehicle information acquisition sensor set 66 is configured including a vehicle speed sensor 68, an acceleration sensor 70, and a steering angle sensor 72. The vehicle speed sensor 68 directly or indirectly detects and outputs the vehicle speed. The acceleration sensor 70 directly or indirectly detects and outputs vehicle acceleration. The steering angle sensor 72 directly or indirectly detects and outputs the steering angle of the vehicle.

The driving assistance ECU 48 is a control section for performing driving assistance in the vehicle 10 without any accompanying driving operation by an occupant. The driving assistance ECU 48 is electrically connected to a throttle actuator 50, a brake actuator 52, and a steering actuator 54.

The throttle actuator 50 is an actuator that changes a throttle position of the vehicle. The brake actuator 52 is an actuator that changes braking force generated by a brake device of the vehicle. The steering actuator 54 is an actuator that changes a steering amount by a steering device of the vehicle.

Note that during driving assistance processing by the driving assistance ECU 48, a situation of the vehicle and its surroundings is determined based on information obtained from the surroundings information acquisition sensor set 56 and the vehicle information acquisition sensor set 66, and the throttle actuator 50, the brake actuator 52, and the steering actuator 54 are controlled according to the situation in the surroundings.

In the present exemplary embodiment, the vehicle 10 can be switched between a driving assistance mode and a manual driving mode. In the driving assistance mode, the vehicle 10 is made to travel without at least some accompanying driving operations by the occupant of the vehicle, as mentioned previously. On the other hand, in the manual driving mode, the occupant performs all of the driving operations. Note that the driving assistance mode of the present exemplary embodiment includes an autonomous driving mode in which the occupant does not perform any driving operations.

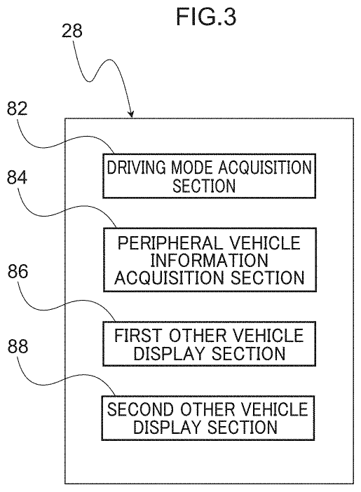

The vehicular display device 28 implements various functionality using the above-described hardware resources. Explanation follows regarding functional configuration implemented by the vehicular display device 28, with reference to FIG. 3.

As illustrated in FIG. 3, the vehicular display device 28 is configured including as functional configuration a driving mode acquisition section 82, a peripheral vehicle information acquisition section 84, a first other vehicle display section 86, and a second other vehicle display section 88. Note that the respective functional configuration is implemented by the CPU 30 reading and executing a program stored in the ROM 32 or the storage 36.

The driving mode acquisition section 82 acquires information regarding the driving mode of the vehicle 10. Specifically, the driving mode acquisition section 82 acquires information regarding whether the driving mode of the vehicle 10 is set to the manual driving mode or set to the driving assistance mode.

The peripheral vehicle information acquisition section 84 acquires information regarding obstacles present in the surroundings of the vehicle 10. Specifically, the peripheral vehicle information acquisition section 84 acquires information detected by the radar devices 62 and image information captured by the cameras 64. In particular, in the present exemplary embodiment, the peripheral vehicle information acquisition section 84 acquires information regarding other vehicles present in the surroundings of the vehicle 10.

In a case in which information has been acquired regarding a first other vehicle present in a first range in the vehicle surroundings, the first other vehicle display section 86 displays a position of this first other vehicle in a display region provided in front of the driving seat. Specifically, the first other vehicle display section 86 of the present exemplary embodiment displays the position of this other vehicle in the display region V3 of the third display section 26.

The first range of the present exemplary embodiment corresponds to a display range of the display region V3. Thus, in a case in which information has been acquired regarding another vehicle in the range of the display region V3, the first other vehicle display section 86 displays the position of this other vehicle in the display region V3.

In a case in which information has been acquired regarding a second other vehicle present in a second range that is further outward than the first range, the second other vehicle display section 88 displays a direction indicating where the second other vehicle is present in a display region. Specifically, the second other vehicle display section 88 of the present exemplary embodiment displays the direction indicating where this other vehicle is present in the display region V3 of the third display section 26.

The second other vehicle display section 88 of the present exemplary embodiment is only configured to display the direction of the other vehicle present in the second range in the display region V3 in a case in which the driving mode of the vehicle 10 is the driving assistance mode.

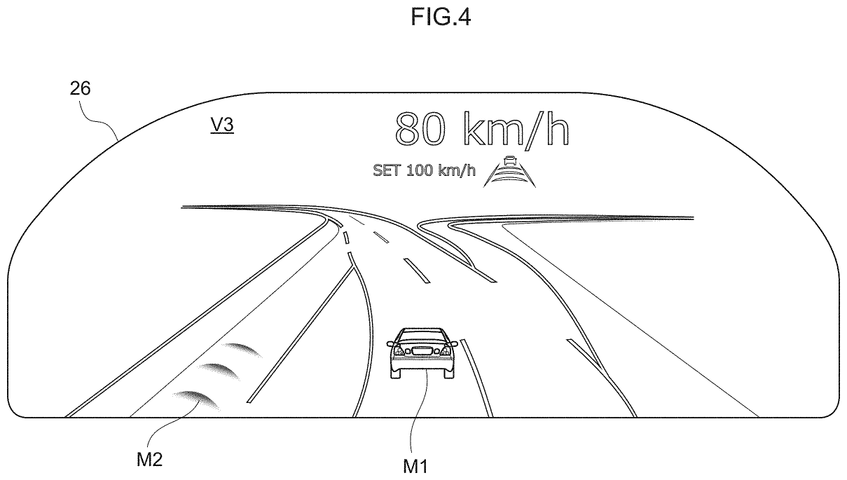

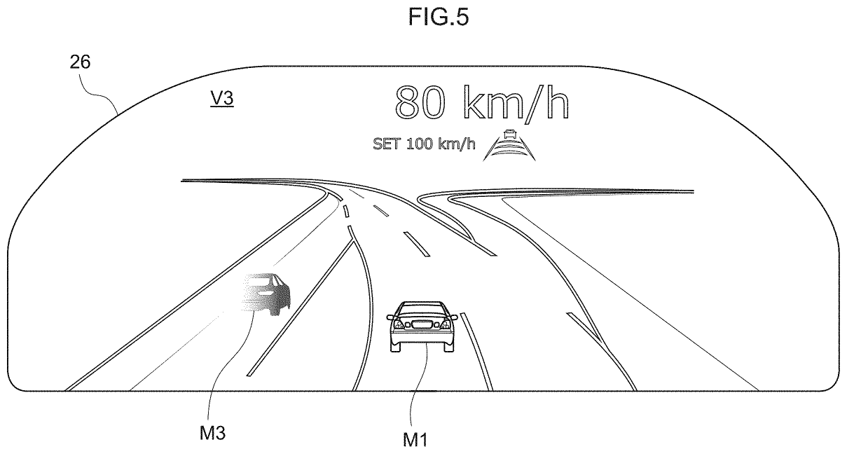

Next, explanation follows regarding examples of display displayed in the display region V3 of the third display section 26, with reference to FIG. 4 and FIG. 5.

As illustrated in FIG. 4, an image corresponding to the surrounding road along which the vehicle 10 is traveling and a mark M1 indicating the position of the ego vehicle are displayed in the display region V3. Note that although a boundary of the display region V3 is illustrated by a solid line in FIG. 4 for ease of explanation, the display region V3 is actually set on part of the windshield glass and this boundary is not displayed. Moreover, although the scene ahead of the vehicle 10 can actually be seen through the windshield glass, only the picture that is being displayed is illustrated in FIG. 4. Similar applies to FIG. 5.

The current speed of the vehicle 10 and a speed setting in the driving assistance mode are displayed at an upper portion of the display region V3. As an example, the speed setting is set to 100 km per hour, and the current speed is 80 km per hour.

Note that an image of a road indicating a merging lane is displayed at a left portion of the display region V3, and marks M2 indicating the direction of a second other vehicle are displayed at a nearest portion of the merging lane. The marks M2 are displayed as an animation. In this animation, three substantially arc-shaped marks M2 are displayed so as to move forward from the near side of the lane (from the lower side to the upper side in FIG. 4). The marks M2 are displayed in the display region V3 using the functionality of the second other vehicle display section 88.

The marks M2 in FIG. 4 indicate the direction of the other vehicle traveling along the merging lane, and make the driver visually aware that the other vehicle is approaching the vehicle 10 from the merging lane.

On the other hand, in FIG. 5, a mark M3 indicating the position of another vehicle traveling along a merging lane is displayed at a left portion of the display region V3. The mark M3 is an image with a shape representing a vehicle, and is displayed in the display region V3 using the functionality of the first other vehicle display section 86. In this manner, in a case in which another vehicle traveling along a merging lane is approaching the vehicle 10, if the other vehicle is present further outward than the first range that is the display range of the display region V3 (if the other vehicle is a second other vehicle), the direction of the other vehicle is displayed as an animation using the marks M2 as illustrated in FIG. 4. In a case in which this other vehicle has approached to within the first range, the position of the other vehicle (now a first other vehicle) is displayed using the mark M3 as illustrated in FIG. 5, and so the display changes from the marks M2 to the mark M3.

Next, explanation follows regarding operation of the present exemplary embodiment.

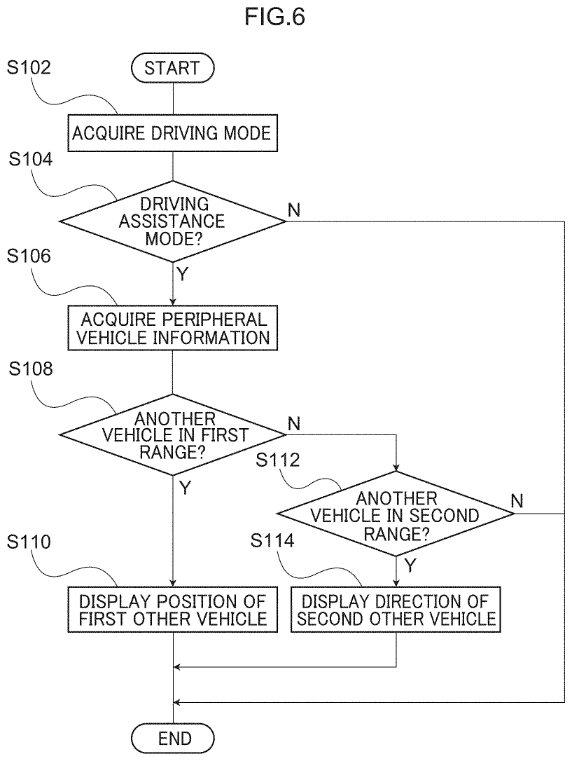

Explanation follows regarding an example of display processing to display the marks M2 or the mark M3 in the display region V3 of the third display section 26, with reference to the flowchart illustrated in FIG. 6. This display processing is executed by the CPU 30 reading the display program from the ROM 32 or the storage 36, and expanding and executing the display program in the RAM 34.

At step S102, the CPU 30 acquires the driving mode of the vehicle 10. Specifically, the vehicle 10 of the present exemplary embodiment has two driving modes, these being the manual driving mode and the driving assistance mode including autonomous driving, and is set to one of these driving modes. The CPU 30 acquires the set driving mode of the vehicle 10 using the functionality of the driving mode acquisition section 82.

At step S104, the CPU 30 determines whether or not the driving mode is the driving assistance mode. In a case in which the driving mode acquired by the CPU 30 at step S102 is the driving assistance mode, step S104 is affirmative and processing transitions to step S106. On the other hand, in a case in which the driving mode acquired by the CPU 30 at step S102 is the manual driving mode, step S104 is negative and the display processing is ended.

At step S106, the CPU 30 acquires information regarding peripheral vehicles present in the vehicle surroundings. Specifically, the CPU 30 uses the functionality of the peripheral vehicle information acquisition section 84 to acquire information regarding other vehicles present in the surroundings of the vehicle 10 based on the information detected by the radar devices 62 and captured by the camera 64.

At step S108, the CPU 30 determines whether or not another vehicle is present in the first range. Specifically, in a case in which the CPU 30 determines that another vehicle detected by the radar devices 62 or captured by the camera 64 is present in the predetermined first range based on the information acquired by the peripheral vehicle information acquisition section 84, processing transitions to step S110. On the other hand, in a case in which the CPU 30 determines that another vehicle is not present in the first range, processing transitions to step S112.

At step S110, the CPU 30 displays the position of the first other vehicle present in the first range in the display region V3. Specifically, the CPU 30 displays the mark M3 representing a vehicle in the display region V3 (see FIG. 5) by projecting a picture onto the display region V3 of the third display section 26 from the head-up display device configured by the third display device 46 using the functionality of the first other vehicle display section 86.

On the other hand, in a case in which the determination of step S110 is negative, at step S112, the CPU 30 determines whether or not another vehicle is present in the second range. Specifically, in a case in which the CPU 30 determines that another vehicle detected by the radar devices 62 or captured by the camera 64 is present in the predetermined second range based on the information acquired by the peripheral vehicle information acquisition section 84, processing transitions to step S114. On the other hand, in a case in which the CPU 30 determines that another vehicle is not present in the second range, the display processing is ended. Thus, other vehicles present outside the second range are not displayed in the display region V3.

In a case in which the CPU 30 determines that another vehicle is present in the second range, at step S114, the direction of the second other vehicle is displayed in the display region V3. Specifically, the CPU 30 displays the marks M2 indicating the direction as an animation in the display region V3 by projecting a picture onto the display region V3 of the third display section 26 from the head-up display device configured by the third display device 46 using the functionality of the second other vehicle display section 88. The CPU 30 then ends the display processing.

As described above, in the vehicular display device 28 of the present exemplary embodiment, the position of the first other vehicle is displayed in the display region V3 provided in front of the driving seat using the mark M3 as illustrated in FIG. 5, thereby enabling the attention of the driver to be directed toward this first other vehicle present in the first range in the vehicle surroundings.

Moreover, in a case in which a second other vehicle is present in the second range that is further outward than the first range, the direction indicating where this second other vehicle is present is displayed in the display region V3 using the marks M2 as illustrated in FIG. 4. This enables any concern felt by the driver toward a vehicle approaching from outside the display region V3 to be suppressed.

Furthermore, in the vehicular display device 28 of the present exemplary embodiment, the direction of the second other vehicle is displayed in the display region V3 while traveling in the driving mode, thereby enabling the occupant to ascertain that any acceleration or deceleration is being performed as a result of this second other vehicle in a case in which the vehicle has accelerated or decelerated without any driving operation intervention by the occupant.

Furthermore, in the vehicular display device 28 of the present exemplary embodiment, since the direction of the second other vehicle is displayed as an animation, the attention of the driver can be better directed toward the second other vehicle than in configurations in which the direction is displayed as a still image. Displaying the direction as an animation enables the driver to intuitively become aware that a vehicle is approaching.

In particular, in the vehicular display device 28 of the present exemplary embodiment, since the direction of the second other vehicle merging from a merging lane is displayed, the driver can be made aware of the direction of the second other vehicle that is merging. For example, in a case in which the merging lane is set at a position that is spaced apart from the main lane, it is difficult for the driver to see vehicles traveling along the merging lane. In the vehicular display device 28 of the present exemplary embodiment, the driver can be suitably made aware of information regarding a second other vehicle that is approaching from the merging lane, even in such situations.

Moreover, in the vehicular display device 28 of the present exemplary embodiment, the direction of the second other vehicle is displayed in the display region V3 set on the windshield glass 18 by the third display device 46. This enables the driver to ascertain the direction of this second other vehicle in a state in which their gaze is directed toward the front.

Although the vehicle 10 and the vehicular display device 28 according to an exemplary embodiment have been described above, obviously various modifications may be implemented within a range not departing from the spirit of the present disclosure. For example, although the second other vehicle display section 88 of the above exemplary embodiment displays the direction of the second other vehicle as an animation using the marks M2 as illustrated in FIG. 4, there is no limitation thereto, and the direction of the second other vehicle may be displayed as a still image. Alternatively, the second other vehicle display section 88 may display the direction of the second other vehicle using text. In such cases, for example, arrows indicating the direction indicating where the second other vehicle is present may be displayed instead of the marks M2, and a message such as “vehicle approaching” may be displayed in the vicinity of the arrows.

Moreover, although in the above exemplary embodiment information regarding the first other vehicle or the second other vehicle is displayed in the display region V3 of the third display section 26 set on the windshield glass 18 by the third display device 46 configured by a head-up display device, there is no limitation thereto. For example, information regarding the first other vehicle or the second other vehicle may be displayed in the display region V1 of the first display section 24, or in the display region V2 of the second display section 25.

Furthermore, configuration may be such that the second other vehicle display section 88 only displays the direction indicating where the second other vehicle is present in the display region in a case in which the distance between the vehicle 10 and the second other vehicle is decreasing, and does not display the direction in a case in which the distance between the vehicle 10 and the second other vehicle is increasing. In such cases, the direction of the other vehicle is not displayed in the display region V3 in a case in which this other vehicle present in the second range is detected to be moving away based on the information detected by the radar devices 62 and the image information captured by the camera 64 at a predetermined cycle. This enables only the most necessary information from the perspective of the driver to be displayed in the display region V3.

Furthermore, although in the above exemplary embodiment information regarding the first other vehicle or the second other vehicle is only displayed in a case in which the driving mode of the vehicle 10 is the driving assistance mode, there is no limitation thereto. For example, information regarding the first other vehicle or the second other vehicle may also be displayed when traveling in the manual driving mode. Moreover, configuration may be such that the driver is able to switch the display ON and OFF.

What is claimed is:

1. A vehicular display device comprising:
a memory; and
a processor coupled to the memory, the processor being configured to:
in a case in which information has been acquired regarding a first other vehicle present in a first range of surroundings of a vehicle, display a position of the first other vehicle at a display region provided in front of a driving seat; and
in a case in which information has been acquired regarding a second other vehicle present in a second range further outward than the first range, display at the display region a direction indicating where the second other vehicle is located.

2. The vehicular display device of claim 1, wherein the processor is configured to display the direction indicating where the second other vehicle is located, in a case in which a distance to the second other vehicle is decreasing, and not to display the direction in a case in which a distance to the second other vehicle is increasing.

3. The vehicular display device of claim 1, wherein the processor is configured to display the direction indicating where the second other vehicle is located, when traveling in a driving assistance mode in which acceleration and deceleration of the vehicle is performed without any driving operation intervention by an occupant.

4. The vehicular display device of claim 1, wherein the processor is configured to display the direction indicating where the second other vehicle is located, as an animation.

5. The vehicular display device of claim 1, wherein the processor is configured to display the direction indicating where the second other vehicle is located, using text.

6. The vehicular display device of claim 1, wherein the processor is configured to perform display in a case in which the second other vehicle is traveling along a merging lane.

7. A vehicle comprising:
the vehicular display device of claim 1; and
a head-up display device configured to display information regarding the first other vehicle and the direction indicating where the second other vehicle is located, in the display region, which is set on a windshield glass.

8. A vehicle comprising:
the vehicular display device of claim 1; and
a display provided inside a cabin of the vehicle and including the display region.

9. A display method comprising:
in a case in which information has been acquired regarding a first other vehicle present in a first range of surroundings of a vehicle, displaying a position of the first other vehicle at a display region, which is provided in front of a driving seat; and
in a case in which information has been acquired regarding a second other vehicle present in a second range further outward than the first range, display at the display region a direction indicating where the second other vehicle is located.

10. A non-transitory computer-readable medium storing a program for causing a computer to execute processing comprising:
in a case in which information has been acquired regarding a first other vehicle present in a first range of surroundings of a vehicle, displaying a position of the first other vehicle at a display region, which is provided in front of a driving seat; and
in a case in which information has been acquired regarding a second other vehicle present in a second range further outward than the first range, display at the display region a direction indicating where the second other vehicle is located.
